(19) United States
(12) Patent Application Publication
(10) Pub. No.: US 2010/0139787 A1
(43) Pub. Date: Jun. 10, 2010

(54) Gas Overflow Safety Protector

(76) Inventor: XUEBO LI, Ningbo (CN)

Correspondence Address: GLOBAL IP SERVICES, 7285 W. Eagle Court, Winton, CA, 95388, US

(21) Appl. No.: 12/465,568

(22) Filed: May 13, 2009

(30) Foreign Application Priority Data
Dec. 10, 2008 (CN) 200820170147.5

(51) Int. Cl. F16K 15/00

(52) U.S. Cl. 137/519.5

(57) ABSTRACT

A gas overflow safety protector comprises a main body including a longitudinal passage for gas; a gas overflow protecting valve disposed in the inlet of the longitudinal passage, which keeps opened under a normal gas pressure and keeps closed under an abnormal gas pressure of overflow; wherein said gas overflow protecting valve including: a valve body including a longitudinal through hole, said longitudinal through hole including a larger-diameter portion as an inlet and a smaller-diameter portion as an outlet, and at least part of the inner wall of said larger-diameter portion being made from magnetic material; a valve core, being a ball made by magnetizer, movably disposed in said larger-diameter portion of the longitudinal through hole for opening or closing said smaller-diameter portion. Compared with the prior art, the gas overflow safety protector of the present invention does not include a spring element. The ball-shaped valve core and the magnetic material on the larger-diameter portion cooperate each other through magnetism so as to protect under the gas overflow. The gas overflow safety protector of the present invention has long usage time, and can be long used in the high temperature, and the structure is simple too.

### CROSS REFERENCE TO RELATED PATENT APPLICATION

The present application claims the priority of the Chinese patent application No. 200820170147.5 filed on Dec. 10, 2008, which application is incorporated herein by reference.

### FIELD OF THE INVENTION

The present invention relates to a kind of gas overflow safety protector coupling between a gas supply tank/pipe and a gas consuming equipment.

### DESCRIPTION OF THE PRIOR ART

Traditional gas supply tank or gas supply pipe only has a control valve, and the flow of the gas supplied for the gas consuming equipment is controlled by a pressure regulator. However, when the pipe which connects the gas supply tank or gas supply pipe to the gas consuming equipment is broken, or other sudden situation occurs, the flow of the gas will suddenly rise, and the accident will probably occur.

Therefore, a gas overflow safety protector is invented, which can be coupled to the control valve of the gas supply tank or of the gas supply pipe. Such gas overflow safety protector can keep open under the normal gas pressure and can keep close under abnormal gas pressure of overflow.

For example, a coupling for connecting a cylinder valve on a gas supply tank to the inlet of a pressure regulator is disclosed in the U.S. Pat. No. 6,688,323. The coupling comprises a nipple having an upstream end for connection with the cylinder valve and a downstream end for connection with the pressure regulator, and a plastic coupling nut for connecting the nipple to the cylinder valve. The end wall of the coupling nut has a metal heat transfer washer on the inner side thereof, and a pressure responsive flexible shutoff valve plate is provided in the nipple passageway. The shutoff vale plate can close the passageway in response to a predetermined pressure, and the end wall of the coupling nut and the heat transfer washer are responsive to a temperature in a predetermined range to release the nipple for displacement away form the cylinder valve in the direction downstream of the nipple. In this patent, the pressure responsive flexible shutoff valve plate can close the gas passageway, so as to ensure the safety under the overflow situation. But such design has a shortcoming, that is, after being used time after time, the elasticity of the shutoff valve plate will probably be reduced, then the gas passageway will not be sealed safely.

For another example, the U.S. Pat. No. 6,155,285 discloses a gas safety valve. It includes a main body having a longitudinal through hole that defines a gas passage, a ball is moved to a position blocking the gas passage when a sudden pressure rise occurs in the inlet of the gas passage, and the ball also can be driven by a spring to move away from the position that blocking the gas passage when a sudden pressure drop occurs in the outlet end of the gas passage.

The similar design as above patent, such as driving a ball to block the gas passage by the force of a spring, are also disclosed in U.S. Pat. No. 7,114,521 and U.S. Pat. No. 5,983,928. In the above mentioned patents, the ball is driven to move by a spring. However the elasticity of the spring will be reduced after being used time after time, it will make against the quick opening of the safety valve. Besides, such gas safety valve is commonly used under a high temperature, the elasticity of the spring will probably be reduced, so the heat insulation and the heat dissipation should be considered, therefore, the structure of the gas safety valve will become more complex.

### SUMMARY OF THE INVENTION

It is an object of the present invention to provide a gas overflow safety protector, which can also keep the gas passage open under the normal gas pressure and keep the gas passage blocked under abnormal gas pressure of overflow without spring element, and to make the safety protector be long used under a high temperature.

For achieving this object, the gas overflow safety protector comprising:

a main body including a longitudinal passage for gas;

a gas overflow protecting valve disposed in the inlet of the longitudinal passage, which keeps opened under a normal gas pressure and keeps closed under an abnormal gas pressure of overflow; wherein said gas overflow protecting valve including:

a valve body including a longitudinal through hole, said longitudinal through hole including a larger-diameter portion as an inlet and a smaller-diameter portion as an outlet, and at least part of the inner wall of said larger-diameter portion being made from magnetic material;

a valve core, being a ball made by magnetizer, movably disposed in said larger-diameter portion of the longitudinal through hole for opening or closing said smaller-diameter portion of the longitudinal through hole.

Said longitudinal through hole of the valve body can be a conic hole. But to make the manufacture easier, the larger-diameter portion and the smaller-diameter portion of said longitudinal through hole of the valve body can both be cylinder holes and an inner shoulder is accordingly formed between these two portions. It went without saying that, the range of the magnetic force of the magnetic material on the larger-diameter portion should satisfy following conditions: under the normal gas pressure, the ball-shaped valve core being attracted by the magnetic larger-diameter portion of the valve body, there is a space between the ball-shaped valve core and the inner shoulder; while, under the predetermined abnormal gas pressure, the attracting force of the magnetic larger-diameter portion of the valve body being overcome, the ball-shaped valve core will be pushed to move and seal the inner shoulder by the gas flow.

Therefore, when the gas flow is in the normal gas pressure, the ball-shaped valve core is attracted by the magnetic part on the larger-diameter portion of the valve body, and there is a space between the ball-shaped valve core and the inner shoulder, then, the gas can pass through the longitudinal through hole normally; when the gas pressure of the gas flow is unacceptably high, that is the predetermined abnormal gas pressure occurs, the ball-shaped valve core will be pushed to move and seal the inner shoulder by the gas flow, the attracting force of the magnetic larger-diameter portion of the valve body being overcome, then, the gas can not enter into the smaller-diameter portion of the valve body and can not pass through the longitudinal through hole too; while, when the gas flow returns to be in normal gas pressure, the ball-shaped valve core is attracted by the magnetic larger-diameter portion, and is once again biased to the normal position, then, the ball-shaped valve core does not seal the inner shoulder, hence the gas can pass normally once again.

As a preference, the inner shoulder can be a conic chamfer. Such design is to form a good seal between the ball-shaped valve core and the conic chamfer; on the other hand, the conic chamfer can better prevent the outer surface of the ball-shaped valve core from being abraded.

In order to match with the control valve of the gas tank, a pushing tube can be disposed in the inlet of the longitudinal passage of the main body, the front end of the pushing tube extends outside the longitudinal passage, the rear end of the pushing tube touches the front end of the valve body, while, the pushing tube has a longitudinal central hole, the portion of the central hole adjacent to the valve body of the gas overflow protecting valve is a conic hole, the diameter of which becomes greater from front to rear, so that the valve core can be pushed by the gas flow more easily. In the same time, the outer surface of the ball-shaped valve core can be prevented from being abraded when rolling.

Preferably, the longitudinal passage of the main body is a step hole having a front portion with larger hole and a rear portion with smaller hole and a shoulder between the front and rear portions, the gas overflow protecting valve is mounted in the front portion and sat on the shoulder.

Preferably, a magnet is embedded n the inner wall of the larger-diameter portion of the longitudinal through hole as part thereof. The magnet can be also instead of an annular magnet.

Compared with the prior art, in this present invention, the longitudinal through hole of the valve body is separated as a larger-diameter portion and a smaller-diameter portion along the gas passage, the inner wall of the larger-diameter portion at least partially being made from magnetic material, and the valve core is a ball made by magnetizer. So that, when the gas flow is in the normal gas pressure, the valve core is attracted by the magnetic larger-diameter portion of the valve body, and the longitudinal through hole of the valve body is unblocked for the gas to flow normally; when the predetermined abnormal gas pressure occurs, for example, the outlet of the gas pipe is broken or leaks, the ball-shaped valve core will be pushed to move and seal the smaller-diameter portion, then the longitudinal through hole of the valve body is blocked. The gas overflow safety protector of the present invention does not include a spring element. The ball-shaped valve core made by magnetizer and the magnetic larger-diameter portion of the valve body cooperate each other through magnetism so as to keep the gas flow in safe pressure. The gas overflow safety protector of the present invention can be long used and can be used in the high temperature, and the structure is simple too.

### BRIEF DESCRIPTION OF THE DRAWINGS

FIG. 1 is an explosive view of the gas overflow safety protector in accordance with an exemplary embodiment of the present invention.

FIG. 2 is a plane view of the gas overflow safety protector from the inlet end.

FIG. 3 is the sectional view of A-A way of FIG. 1 when the gas overflow protecting valve is open.

FIG. 4 is the sectional view of A-A way of FIG. 1 when the gas overflow protecting valve is close.

### DETAILED DESCRIPTION OF THE PREFERRED EMBODIMENT

To enable a further understanding of the innovative and technological content of the invention herein, refer to the detailed description of the invention and the accompanying drawings below:

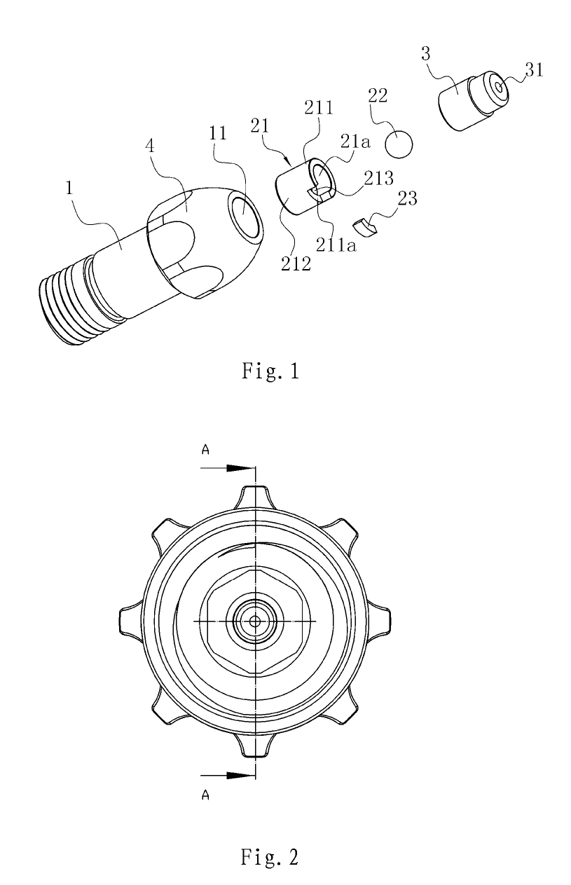

FIGS. 1˜4 show an embodiment of the present invention.

In this embodiment, the gas overflow safety protector comprises a cupreous coupling as a main body 1, which has a longitudinal passage 11 for gas, the longitudinal passage 11 having an externally threaded outlet. A gas overflow protecting valve disposed in the inlet of the longitudinal passage 11, said valve keeps opened under a normal gas pressure and keeps closed under an abnormal gas pressure of overflow. The longitudinal passage 11 of the main body is a step hole having a front portion with larger hole and a rear portion with smaller hole and a shoulder between the front and rear portions, the gas overflow protecting valve is mounted in the front portion and sat on the shoulder. In order to make the using convenient, a plastic handwheel 4 is disposed around the main body 1 to increase the friction when hand assembling.

Wherein the gas overflow protecting valve includes a cupreous valve body 21 and a valve core 22. The valve body 21 has a cylinder longitudinal through hole 21a with an inner shoulder 213, the longitudinal through hole 21a includes a larger-diameter portion 211 as an inlet and a smaller-diameter portion 212 as an outlet along the flow direction of the gas, the inner shoulder 213 between the larger-diameter portion 211 and the smaller-diameter portion 212 has a conic chamfer. While, the inner wall of the larger-diameter portion 211 has a recess 211a in which a magnet 23 disposed, as shown in FIG. 1.

The valve core 22 is a ball made by magnetizer and is movably disposed in the larger-diameter portion 211 of the longitudinal through hole touching the inner shoulder 213 to seal the smaller-diameter portion 212 of the longitudinal through hole. The distance between the center of the magnet 23 and the inner shoulder 213 reaches at least the radius of the ball-shaped valve core 22, so that the ball-shaped valve core 22 can keep a distance with the inner shoulder 213 under the attraction of the magnet 23 when the gas pressure is normal.

It went without saying that, the range of the magnetic force of the magnet 23 on the larger-diameter portion 211 should satisfy following conditions: under the normal gas pressure, the ball-shaped valve core 22 will be attracted by the magnet 23 on the larger-diameter portion 211 of the longitudinal through hole, and then, there is a space between the ball-shaped valve core 22 and the inner shoulder 213; while, under the predetermined abnormal gas pressure, the attracting force of the magnet 23 on the larger-diameter portion 211 of the longitudinal through hole being overcome, the ball-shaped valve core 22 will be pushed to move and seal the inner shoulder 213 by the gas flow. In this embodiment, the magnet 23 is a little block made from high magnetic intensity material.

To make the manufacture convenient, the magnet 23 can also be a ring made from low magnetic intensity material and is embedded in the inner wall of the larger-diameter portion 211 of the longitudinal through hole as part thereof or directly disposed in the front end of the valve body 21.

Besides, in this embodiment, a pushing tube 3 is disposed in the inlet of the passage of the main body 1, the front end 31 of the pushing tube 3 extends outside the longitudinal passage 11, the rear end 32 of the pushing tube 3 touches the front end of the valve body 21, while, the pushing tube 3 has a longitudinal central hole 31, the portion of the central hole 31 adjacent to the valve body 21 is a conic hole, the diameter of which becomes greater from front to rear, so that the valve core 22 can be pushed by the gas flow more easily. In the same time, the outer surface of the ball-shaped valve core 22 can be prevented from being abraded when rolling.

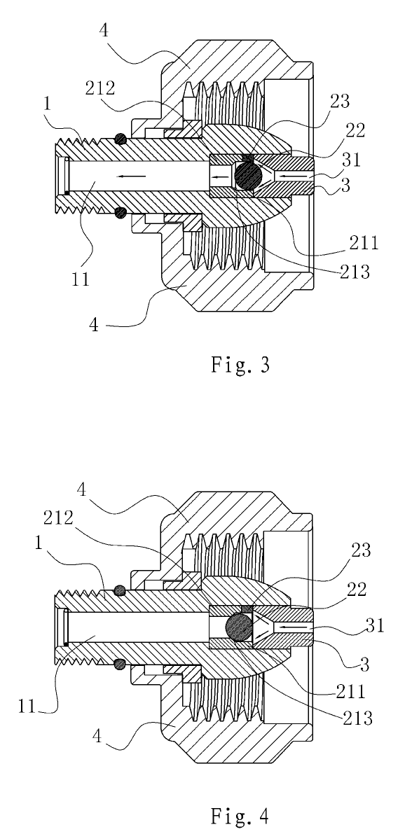

When the gas overflow safety protector of the present invention is working, the ball-shaped valve core 22 is attracted by the magnetic larger-diameter portion 211 of the longitudinal through hole under the normal gas pressure, as shown in FIG. 3. There is a space between the valve core 22 and the inner shoulder 213, and then the gas can flow along the arrow direction shown in FIG. 3.

When the gas pressure of the gas flow is unacceptably high, that is the predetermined abnormal gas pressure occurs, for example, the outlet of the gas pipe is broken or leaks, the attracting force of the magnet 23 on the larger-diameter portion 211 of the longitudinal through hole being overcome, the valve core 22 will be pushed to move and seal the inner shoulder 213, as shown in FIG. 4. Then, the gas cannot enter into the smaller-diameter portion 212 of the longitudinal through hole and cannot pass through the longitudinal through hole 21a too. While, when the gas flow returns to be in normal gas pressure, the valve core 22 is attracted by the magnet 23 on the larger-diameter portion 211, and is once again biased to the normal position as shown in FIG. 3. Then, the space between the valve core 22 and the inner shoulder 213 is formed again; hence the gas can pass normally once again.

What is claimed is:

1. A gas overflow safety protector comprising:
a main body (1) including a longitudinal passage (11) for gas;
a gas overflow protecting valve disposed in the inlet of the longitudinal passage (11), which keeps opened under a normal gas pressure and keeps closed under an abnormal gas pressure of overflow; wherein said gas overflow protecting valve including:
a valve body (21) including a longitudinal through hole (21a), said longitudinal through hole (21a) including a larger-diameter portion (211) as an inlet and a smaller-diameter portion (212) as an outlet, and at least part of the inner wall of said larger-diameter portion (211) being made from magnetic material;
a valve core (22) being a ball made by magnetizer, movably disposed in said larger-diameter portion (211) of the longitudinal through hole (21a) for opening or closing said smaller-diameter portion (212) of the longitudinal through hole (21a).

2. The gas overflow safety protector of claim 1, wherein the larger-diameter portion (211) and the smaller-diameter portion (212) of the valve body are both cylinder holes, and an inner shoulder (213) is accordingly formed between these two portions.

3. The gas overflow safety protector of claim 2, wherein the inner shoulder (213) has a conic chamfer.

4. The gas overflow safety protector of claim 1, wherein a pushing tube (3) having a conic hole at one end is mounted in the inlet of the longitudinal passage of the main body (1), the front end of the pushing tube (3) extends outside the longitudinal passage (11), the rear end of a the pushing tube (3) touches the front end of the valve body (21), while, said pushing tube (3) has a longitudinal central hole (31), the portion of the central hole (31) adjacent to the valve body (21) of the gas overflow protecting valve is a conic hole, the diameter of which becomes greater from front to rear.

5. The gas overflow safety protector of claim 4, wherein the longitudinal passage (11) of the main body (1) is a step hole having a front portion with larger hole and a rear portion with smaller hole and a shoulder between the front and rear portions, the gas overflow protecting valve is mounted in the front portion and sat on the shoulder.

6. The gas overflow safety protector of claim 1, wherein a magnet (23) is embedded in the inner wall of the larger-diameter portion (211) of the longitudinal through hole (21a) as part thereof.

7. The gas overflow safety protector of claim 1, wherein an annular magnet is embedded in the inner wall of the longitudinal through hole (21a) as part thereof.

8. The gas overflow safety protector of claim 1, wherein the ball is made by ferromagnetic.
